(19) United States
(12) Patent Application Publication
(10) Pub. No.: US 2021/0386207 A1
(43) Pub. Date: Dec. 16, 2021

(54) HEADBOARD AND BED

(71) Applicants: Chao Deng, Shenzhen, Guangdong (CN); Douglas R. Spencer, Seattle, WA (US)

(72) Inventors: Chao Deng, Shenzhen, Guangdong (CN); Douglas R. Spencer, Seattle, WA (US)

(21) Appl. No.: 17/343,929

(22) Filed: Jun. 10, 2021

(30) Foreign Application Priority Data
Jun. 10, 2020 (CN) 202021054426.2

(51) Int. Cl. A47C 19/02; A47C 19/12; A47C 19/00; F16B 12/56

(52) U.S. Cl. CPC A47C 19/022; F16B 12/56; A47C 19/005; A47C 19/12

(57) ABSTRACT

Disclosed are a headboard and a bed, relating to the field of furniture. The headboard includes at least two panels and at least one folding connection member, wherein the folding connection member is disposed between two neighboring panels, a first side of the folding connection member being connected to one of the two neighboring panels, the second side of the folding connection member being connected to the other headboard of the two neighboring panels, thereby rendering the at least two panels foldable. With the at least two panels and the at least one folding connection member, the headboard disclosed may realize folding between respective panels so as to reduce package size, facilitate shipping and delivery, and reduce cost. Furthermore, the headboard disclosed is easy to disassemble and assemble, simple in structure, and convenient in use, with certain aesthetics and comfort.

### CROSS REFERENCE TO RELATED APPLICATIONS

The present application claims the benefit of Chinese Patent Application No. 202021054426.2 filed on Jun. 10, 2020, the contents of which are incorporated herein by reference in their entirety.

### FIELD

Embodiments of the present disclosure relate to the field of furniture, and more particularly relate to a headboard and a bed.

### BACKGROUND

With development of e-commerce furniture businesses, assembled furniture is largely sold online and shipped via logistics. The headboard of a bed is generally of an unsplit structure made of wood or wrapped with soft coverings. The front surface of the headboard is usually finished or wrapped with soft coverings. The lower part of the headboard may be affixed with fixed or detachable support legs so as to be mounted to sideboards, wherein the headboard, the sideboards and the footboard are assembled to form a bed set; or, the headboard is legless, mounted independently to a wall. However, on one hand, the headboards currently sold in the market are mostly of an unsplit piece. Their bulky size is inconvenient for shipping and delivery. Particularly, the logistic industry has strict restrictions on sizes for packaging and shipping. For example, it requires that the longest edge of a package box for small parcels shall not exceed a specified length; otherwise a surcharge will be imposed for shipping and delivery services. For a common double bed, its length always exceeds the standards of small parcel packages, which increases shipping costs and further dampens sales. On the other hand, although some foldable headboards emerge in the market, the panels of the headboard need to be sequentially detached for packaging, which requires the consumers to assemble later, in which cases mistaken assembly easily occurs. There are also some foldable headboards whose panels are connected via flexible connecting members. With the flexible connecting members, the panels can be folded at the boundary between fully opened positions. However, considering potential collisions, falling or other impact instances during shipping, the joints between panels via the flexible connecting members are likely subjected to impact, pull or tear, which causes potential damages to the headboard.

Therefore, to address the above and other problems, it is needed to provide a headboard structure, which may significantly reduce package size, facilitate shipping and delivery, and eliminate a subsequent complex assembly process.

### SUMMARY

To solve at least one of the technical problems in traditional technologies, embodiments of the present disclosure provide a headboard and a bed.

In one aspect of the present disclosure, there is provided a headboard, comprising: at least two panels and at least one folding connection member, wherein the at least two panels include:

a first panel; and

a second panel arranged adjacent to the first panel along the width direction of the headboard; and

the folding connection member is arranged between the first panel and the second panel, connected to the first panel and the second panel respectively.

In an embodiment, a plurality of folding connection members are arranged between the adjacent first panel and second panel, the plurality of folding connection members being arranged at even or uneven intervals along the width direction of the headboard.

In an embodiment, the folding connection member selects a rigid folding connection member or a flexible folding connection member.

In an embodiment, the folding connection member includes a rotating shaft, and a first folding piece and a second folding piece that are respectively in rotatable connection with the rotating shaft, wherein:

the first folding piece is connected to the first panel, and the second folding piece is connected to the second panel.

In an embodiment, the headboard further comprises at least one fastening member, wherein when the at least two panels are in an unfolded state, the fastening member is disposed across the at least two panels, a first end of the fastening member being connected to a first panel, a second end of the fastening member being connected to a last panel.

In an embodiment, the fastening member comprises a fixed connecting piece, a first fastening piece and a second fastening piece; wherein

the fixed connecting piece is disposed across the at least two panels, one end of the fixed connecting piece being secured to the first panel via the first fastening piece, the other end of the fixed connecting piece being secured to the last panel via the second fastening piece.

In an embodiment, the fixed connecting piece selects a screw fixed connecting piece; and/or, the first fastening piece and the second fastening piece select a bolt fastening piece.

In an embodiment, the headboard further comprises at least two soft coverings, the soft coverings sequentially wrapping the corresponding panels; or, the at least two soft coverings are integrally formed to wrap the at least two panels so as to conceal the folding connection member.

In an embodiment, the headboard further comprises a third panel arranged between the first panel and the second panel, the third panel being respectively in foldable connection with the first panel and the second panel.

In an embodiment, when the headboard is in a folded state, the first panel is parallel to the second panel, and the third panel is perpendicular to the first panel and the second panel.

In another aspect of the present disclosure, there is provided a bed, comprising: a bed body and a headboard, wherein the headboard refers to the one described above.

Embodiments of the present disclosure provide a headboard, comprising: at least two panels and at least one folding connection member, wherein one folding connection member is arranged between two neighboring panels, a first side of the folding connection member being connected to one of the two neighboring panels, and a second side of the folding connection member being connected to the other one of the two neighboring panels, rendering the at least two panels foldable. The foldable headboard according to the embodiments of the present disclosure can significantly reduce package size and facilitate shipping and delivery, thereby significantly reducing shipping cost.

### BRIEF DESCRIPTION OF THE SEVERAL VIEWS OF THE DRAWINGS

FIG. 1 shows a structural schematic diagram of a headboard in an expanded state according to an embodiment of the present disclosure;

FIG. 2 shows a structural schematic diagram of a headboard in an expanded state according to another embodiment of the present disclosure;

FIG. 3 shows a structural schematic diagram of a headboard in a folded state according to another embodiment of the present disclosure;

FIG. 4 shows a structural schematic diagram of a headboard in an expanded state according to another embodiment of the present disclosure;

FIG. 5 shows a structural schematic diagram of a headboard in an expanded state according to another embodiment of the present disclosure;

FIG. 6 shows a structural schematic diagram of a headboard in an expanded state according to another embodiment of the present disclosure;

FIG. 7 shows a structural schematic diagram of a headboard in an expanded state according to another embodiment of the present disclosure;

FIG. 8 is an enlarged view of part A in FIG. 7 according to an embodiment of the present disclosure;

FIG. 9 shows a structural schematic diagram of a folded structure of a headboard according to another embodiment of the present disclosure;

FIG. 10 shows a structural schematic diagram of a packaged structure of a headboard according to another embodiment of the present disclosure.

### DETAILED DESCRIPTION

To enable those skilled in the art to better understand the technical solution of the present disclosure, the present disclosure will be described in further detail through preferred embodiments with reference to the accompanying drawings. Apparently, the embodiments described herein are only part of the embodiments of the present disclosure, not all of them. Based on the embodiments of the present disclosure as described, all other embodiments obtained by those skilled in the art without exercise of inventive work all fall within the protection scope of the present disclosure.

Unless otherwise indicated, the technical terms or scientific terms used herein should have common meanings appreciated by those skilled in the art. The phrase “include” or “comprise” used herein does not limit the referred to shape, number, step, action, operation, member, element and/or the group to which they belong, nor does it exclude occurrence or addition of one or more other shapes, numbers, steps, actions, operations, members, elements and/or groups to which they belong. Besides, the terms “first” and “second” are only used for descriptive purposes, which shall not be construed as indicating or implying a relative importance or implicitly indicating the number or sequence of the technical features referred to. Therefore, a feature limited by “first” and “second” may explicitly or implicitly include one or more of such features. In the description of the present disclosure, unless otherwise indicated, “plurality” indicates two or more.

In some depictions of the present disclosure, unless otherwise specified and limited, an oriental or positional relationship indicated by the term “central,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “peripheral” or the like refer to the corresponding oriental or positional relationship illustrated in the drawings, which is used to only indicate a relative positional relationship; when the absolute position of a described object changes, the relative positional relationship likely changes accordingly.

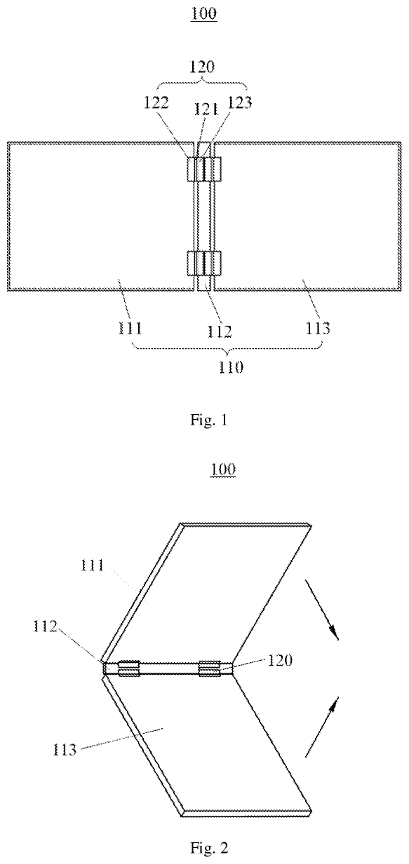

As shown in FIGS. 1-5, in one aspect of the present disclosure, there is provided a headboard 100, comprising: at least two panels 110 (111/112/113) and at least one folding connection member 120; wherein one folding connection member 120 is arranged between two neighboring panels (e.g., in the case of three panels, the two neighboring panels refer to panels 111/112 or 112/113), the two neighboring panels being connected via the folding connection member 120 along the width direction of the headboard (i.e., the direction vertical to the ground when the headboard is in use); a first end of the folding connection member 120 is connected to one of the two neighboring panels, a second end of the folding connection member 120 is connected to the other one of the two neighboring panels, rendering the at least two panels foldable. In other words, by sequentially connecting every two neighboring panels via the folding connection members, an integral foldable headboard is formed.

In an embodiment, the headboard comprises at least two panels and at least one folding connection member, wherein one folding connection member is arranged between two neighboring panels; a first side of the folding connection member is connected to one of the two neighboring panels, and a second side of the folding connection member is connected to the other of the two neighboring panels, rendering the at least two panel foldable. In this way, the package size can be significantly reduced to facilitate shipping and delivery, and cost can also be significantly reduced.

It is noted that the horizontal length of a headboard is generally longer, far exceeding a package box size for shipping and thus not meeting transportation standards. In this embodiment, the headboard is split into at least two panels along the horizontal direction, wherein the respective panels are in foldable connection via at least one folding connection member. As such, the respective panels are folded along the horizontal direction via the at least one folding connection member, thereby reducing package size.

It is further noted that this embodiment has no limitations on the quantity, shape, and size of the panels. Two, three, four, or more panels may be provided, wherein the respective panels are connected along the width direction of the headboard. Of course, these panels may have a square, rectangular, or other irregular shape. Additionally, the sizes of the panels may be equal, i.e., the size of each panel is identical, such that projections of the folded panels are totally coincident, thereby reducing package size. Of course, the panel sizes may be set different, e.g., one or more panels in the middle are set shorter than the other panels, wherein the intermediate one or more panels are vertically supported between the panels respectively disposed at both sides. The above configurations may be selected by those skilled in the art based on actual needs.

It is still noted that the quantity of folding connection members arranged between two neighboring panels is not limited either. In an alternative embodiment, one folding connection member may be arranged between two neighboring panels, and in other alternative embodiments, two or three or more folding connection members may be arranged. Moreover, the plurality of folding connection members may be arranged at even or uneven intervals along the width (longitudinal) direction of the panels.

In an exemplary embodiment, please refer to FIGS. 1 to 5, where a case of three panels is illustrated. Specifically, the panel 100 comprises three panels 110, which are respectively a first panel 111, a second panel 113, and a third panel 112 disposed between the first panel 111 and the second panel 113, wherein the three panels are connected via folding connection members.

Furthermore, the folding connection member 120 in this embodiment may include a rotating shaft 121, and a first folding piece 122 and a second folding piece 123 that are rotatably connected, wherein the first folding piece 122 is connected to one (e.g., the first panel 111 or the third panel 112) of two neighboring panels (111/112 or 112/113), and the second folding piece 123 is connected to the other one (for another example, the third panel 112 or the second panel 113) of the two neighboring panels (111/112 or 112/113). In other words, the first panel and the third panel are connected via the first folding connection member, and the second panel and the third panel are connected via the second folding connection member, thereby forming an integral foldable headboard.

It is noted that although folding between the respective panels connected can be realized via a flexible connecting member (e.g., cloth, leather, sponge, etc.), collision, pull or tear of a certain extent still likely occurs to potentially damage the product during shipping, because the flexible joints between the respective panels are not rigid enough for support. To address this issue, Inventors have conducted a long-term research, finding that to guarantee an intact protection to various parts of the product during shipping, a rigid connecting part should be applied in cooperation with the folding member.

Specifically, in this embodiment, the second panel in the middle serves as a connecting plate between two neighboring panels, which is a rigid connecting member. Folding between the first panel and the third panel may be implemented via the connecting plate with the folding connection member between the panels. The connecting plate forms a certain support to the first panel and the third panel while maintaining a certain interval there between. The longitudinal length of the connecting plate is identical to that of the first/third panel, while the width thereof may be set according to actual needs.

It is further noted that this embodiment has no specific limitations on the structure of the folding connection member, which for example can be a flip fitting (hinge), a woven tape or a cloth strip, so long as it can connect the panels together. Specifically, this embodiment adopts a hinge as the folding connection member for connection, such that two panels are rotatable relative to each other. This configuration enables the panels to be folded and expanded, which facilitates assembly and disassembly while reducing package size and easing transportation.

Specifically, as shown in FIGS. 1-5, in this embodiment, the size of the third panel is apparently smaller than that of the first and second panel respectively disposed at both sides, wherein the third panel serves as a connecting plate. To further reduce package size, the size of the first panel is set to be identical to that of the second panel. Four hinges are used to connect the respective panels. In this way, the respective panels may be folded forward or backward via the hinges. When the headboard 100 is in a folded state, the first panel 111 is parallel to the second panel 113, and the third panel 112 is perpendicular to the first panel 111 and the second panel 113. In other words, when the panels are folded, the third panel serves as a connecting plate, assuming a 90° angle relative to the first panel and the second panel, respectively, thereby spacing the first panel from the second panel and creating an interval of a width of the connecting plate. In this way, the headboard can be fully folded to be packaged into a box. This approach reduces at least 50% of the length of the longest edge of the headboard package box, thereby meeting the efficient transportation standards and requirements of logistic companies, facilitating the logistic companies to ship and deliver, reducing shipping costs, and generating a huge economic benefit.

It is appreciated that in some embodiments, four panels may be provided. The respective panels are connected via the folding connection members. Of course, the four panels may be arranged to have the same size. In this way, when being folded forward or backward, the respective panels may rotate relative to each other via the folding connection members to result in a completely overlapping state, i.e., the four panels are stacked together to further reduce package size and shipping cost.

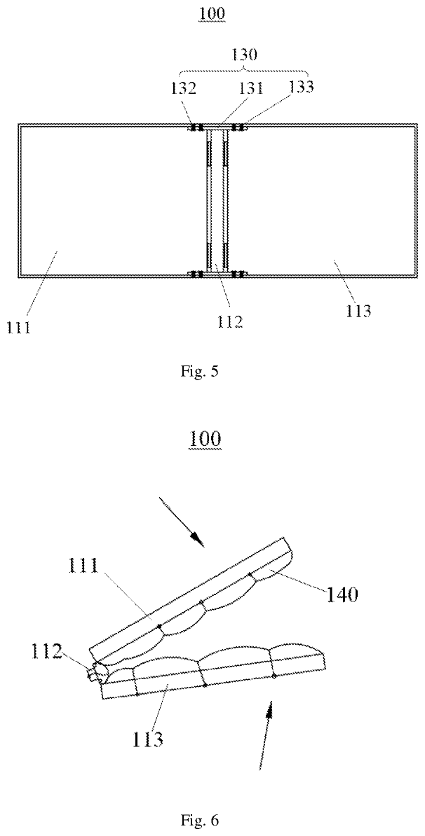

In an alternative embodiment, as shown in FIG. 5, the headboard 100 further comprises a fastening member 130, wherein when the at least two panels 110 are in an expanded state, the fastening member 130 is disposed across the at least two panels 110, a first end of the fastening member 130 being connected to the first panel 111, and a second end of the fastening member 130 being connected to the last panel 113. In other words, after the folded panels are expanded, it is only needed to mount the fastening member to one side of all panels (i.e., the front side or the rear side of the headboard). Of course, to achieve an overall aesthetic appearance, the fastening member may be disposed at the rear side of the panels so as to form a solid integral headboard that is simple in structure and easy to assemble.

Specifically, the fastening member 130 comprises a fixed connecting piece 131, a first fastening piece 132 and a second fastening piece 133. In this embodiment, the fixed connecting piece 131 is disposed across the at least two panels 110, one end of the fixed connecting piece 130 being secured to the first panel 111 via the first fastening piece 132, and the other end of the fixed connecting piece 131 being secured to the last panel 113 via the second fastening piece 133.

It is understood that to those skilled in the art, the fixed connecting piece 131 in this embodiment may select a screw fixed connecting piece, and/or the first fastening piece 132 and the second fastening piece 133 select a bolt fastening piece. In conjunction with FIG. 5, in some embodiments, in cases of three panels, it is needed to secure the screw fixed connecting piece 131 to the side extending across three panels (111/112/113), and then secure the screw fixed connecting piece 131 to the panels respectively disposed at both sides (i.e., the first panel 111 and the third panel 113) via the bolt fastening pieces 132/133, thereby fastening the headboard. Of course, besides the fastening member comprising a screw fixed connecting piece and two bolt fastening pieces, other kinds of fastening members may also be selected, which is not limited herein.

It is noted that this embodiment does not limit the quantity of the fastening member and its position. The fastening member may be arranged at the upper end of a panel, or the fastening member is arranged at both upper and lower ends of the panel. Alternatively, the fastening member may also be arranged in the middle position. They are not specifically limited herein.

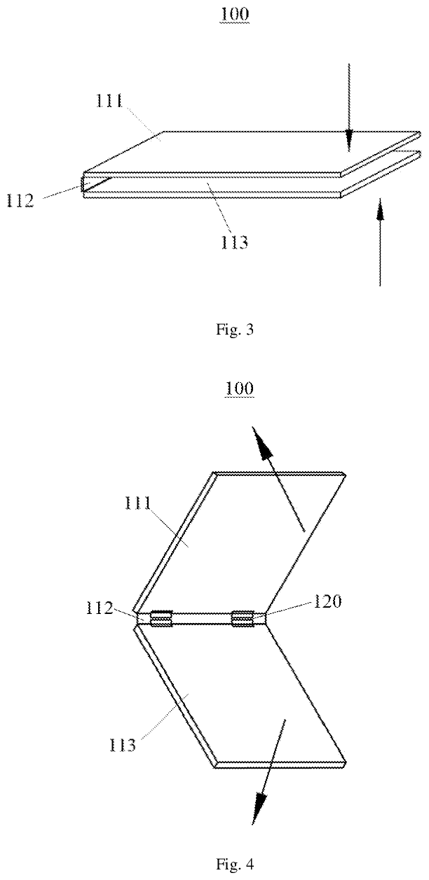

It is further noted that as shown in FIGS. 1-5, this embodiment provides specific processes of folding and expanding a headboard. FIG. 1 shows the specific expanded state when the panels are connected via a folding connection member; FIG. 2 shows the folded state of the panels via the folding connection member, FIG. 3 shows the state in which the panels are fully folded, wherein this state is used for packaging and shipping; FIG. 4 shows a state in which the folded panels are sequentially unfolded; and FIG. 5 shows assembling the opened panels into a headboard set via a fastening member.

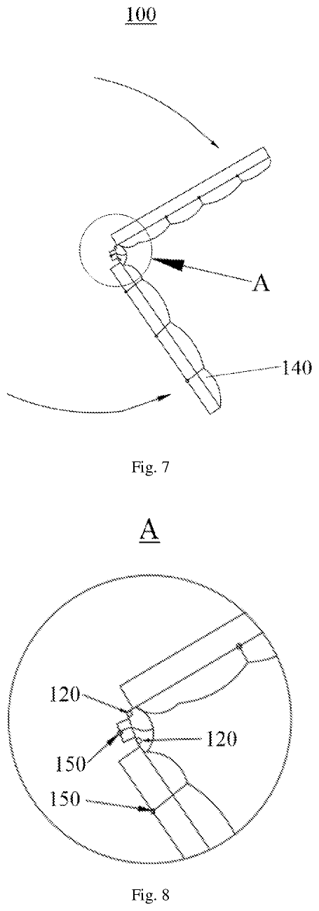

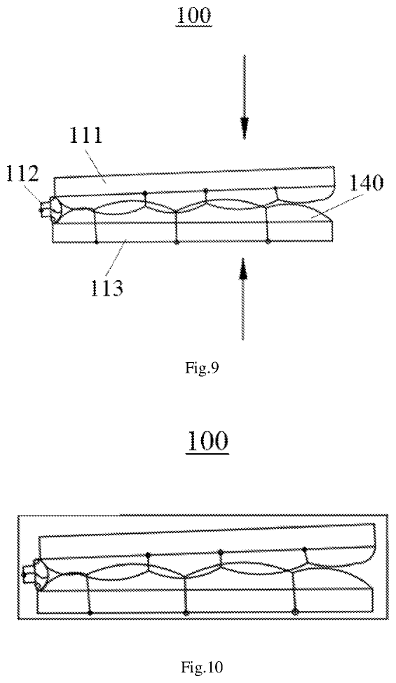

Alternatively, in some other embodiments, for the sake of overall aesthetic appearance and comfort of the headboard, as shown in FIGS. 6-10, the headboard 100 may further comprise at least two soft coverings 140. The soft coverings 140 may be separately provided, i.e., sequentially wrapping corresponding individual panels (111/112/113). Of course, the at least two soft coverings 140 may be integrally formed, i.e., respective soft coverings are connected to form a one-piece soft covering. The one-piece soft covering 140 wraps the at least two panels to conceal the folding connection member. It is understood that the soft coverings should wrap one side (front side) of the panels so as to conceal the folding connection member and the gap between two neighboring panels when the panels are expanded. In this way, besides beautifying the headboard, the soft coverings wrapping the headboard may also play roles of sound absorption, sound insulation, moisture proof, and collision proof.

It is understood that because the headboard in this embodiment is formed by connecting the first panel and the second panel respectively disposed at both sides via the intermediate connecting plate (e.g., the third panel), after the panels are folded, the first panel and the second panel are supported and spaced by the connecting plate, with an interval existing between the first panel and the second panel. As such, when manufacturing a soft covering wrapped headboard, since the soft covering usually has a thickness of 1 cm to 5 cm, the interval space can offset or absorb the thickness of the soft covering; in this way, when being packaged, the soft covering does not bear a direct pressure and thus can provide an intact protection to the product during shipping.

It is noted that the width of the connecting plate is not specifically limited here, which may be set based on the thickness of the soft covering. For example, in cases of only folding the first panel and the second panel, the width of the connecting plate is twice the thickness of the soft covering.

It is noted that the manner of securing the soft coverings around the panels is not specifically limited herein. In an exemplary embodiment, as shown in FIG. 8, a wrapping process may be directly applied to secure them around respective panels, or one or more pull lock cords 150 may be provided between the soft coverings and the panels so as to secure them around the panels. Of course, for the sake of aesthetic appearance, a plurality of pull lock cords may be provided at even intervals on the soft coverings, which may not only play a fastening role, but also may render the soft coverings swelled to provide a certain aesthetic appearance and comfort.

Specifically, as shown in FIGS. 6-10, some further embodiments provide schematic diagrams of the folded and expanded states of the headboard with soft coverings. The illustrations are also made with three panels as an example. When the three panels are folded together, the first panel 111 and the second panel 113 are disposed in parallel, and the third panel 112 is perpendicularly disposed between them to serve as a connecting plate. In this way, the first panel and the second panel are opposite to each other at the respective sides wrapped with the soft coverings, and the two layers of the soft coverings 140 are attached together, preventing serious squeezing to cause deformation and damage to the soft coverings during packaging and shipping.

In this embodiment, folding between respective panels is implemented via the rigid connecting plate and the folding connection member; besides, the respective panels are spaced with a certain interval to accommodate the thickness of the soft coverings, which not only protects the soft coverings, but also reduces package size. In contrast, if a flexible connecting member is adopted, no support space exists between the panels, such that a structure like soft covering cannot be provided between the panels, still causing potential damages during shipping.

Another aspect of the present disclosure provides a bed comprising a bed body and a headboard, wherein the headboard refers to the one described above. The specific structure of the headboard has been described above, which will not be detailed here. It is understood that the headboard may be a headboard formed by direct connection of a plurality of panels, or a headboard with respective panels wrapped with soft coverings. The present disclosure has no limitations thereto.

The present disclosure provides a headboard and a bed. Compared with traditional technologies, the headboard provided by the present disclosure offers the following benefits: with rigid connecting plates and folding connection members provided between respective panels, folding of the panels is realized to significantly reduce package size, thereby facilitating shipping and delivery and reducing shipping costs. On the other hand, the rigid connecting plate plays a certain support role to the panels respectively disposed at both sides, which provides a certain gap between respective panels to accommodate a structure such as soft coverings. In this way, the soft coverings do not bear direct pressures during packaging, thereby providing intact protection to the product during shipping. Besides, this configuration also provides certain aesthetic appearance and comfort. Additionally, the headboard according to the present disclosure is simple in structure. During packaging and shipping, the panels are directly folded without a need of disassembling the panels and other components; and in subsequent use, it is only needed to directly unfold the panels without a trouble to re-assemble the various parts.

It is understood that the embodiments above are only exemplary embodiments for illustrating the principle of the present disclosure; however, the present disclosure is not limited thereto. To those of normal skill in the art, various modifications and improvements may be made without departing from the spirit and substance of the present disclosure, and such modifications and improvements are also deemed as falling into the protection scope of the present disclosure.

I/We claim:

1. A headboard, comprising: at least two panels and at least one folding connection member, wherein the at least two panels include:
a first panel; and
a second panel arranged adjacent to the first panel along the width direction of the headboard; and
the folding connection member is arranged between the first panel and the second panel, connected to the first panel and the second panel respectively.

2. The headboard according to claim 1, wherein a plurality of folding connection members are arranged between the adjacent first panel and second panel, the plurality of folding connection members being arranged at even or uneven intervals along the width direction of the headboard.

3. The headboard according to claim 1, wherein the folding connection member selects a rigid folding connection member or a flexible folding connection member.

4. The headboard according to claim 1, wherein the folding connection member includes a rotating shaft, and a first folding piece and a second folding piece that are respectively in rotatable connection with the rotating shaft, wherein:
the first folding piece is connected to the first panel, and the second folding piece is connected to the second panel.

5. The headboard according to claim 1, further comprising at least one fastening member, wherein when the at least two panels are in an unfolded state, the fastening member is disposed across the at least two panels, a first end of the fastening member being connected to a first panel, a second end of the fastening member being connected to a last panel.

6. The headboard according to claim 5, wherein the fastening member comprises a fixed connecting piece, a first fastening piece and a second fastening piece; wherein:
the fixed connecting piece is disposed across the at least two panels, one end of the fixed connecting piece being secured to the first panel via the first fastening piece, the other end of the fixed connecting piece being secured to the last panel via the second fastening piece.

7. The headboard according to claim 6, wherein the fixed connecting piece selects a screw fixed connecting piece; and/or, the first fastening piece and the second fastening piece select a bolt fastening piece.

8. The headboard according to claim 1, wherein the headboard further comprises at least two soft coverings, the soft coverings sequentially wrapping the corresponding panels; or, the at least two soft coverings are integrally formed to wrap the at least two panels so as to conceal the folding connection member.

9. The headboard according to claim 1, further comprising a third panel arranged between the first panel and the second panel, the third panel being respectively in foldable connection with the first panel and the second panel.

10. A bed, comprising:
a bed body; and
a headboard including at least two panels and at least one folding connection member, wherein the at least two panels include:
a first panel; and
a second panel arranged adjacent to the first panel along the width direction of the headboard; and
wherein the folding connection member is arranged between the first panel and the second panel, connected to the first panel and the second panel respectively.

11. The bed according to claim 10, wherein a plurality of folding connection members are arranged between the adjacent first panel and second panel, the plurality of folding connection members being arranged at even or uneven intervals along the width direction of the headboard.

12. The bed according to claim 10, wherein the folding connection member selects a rigid folding connection member or a flexible folding connection member.

13. The bed according to claim 10, wherein the folding connection member includes a rotating shaft, and a first folding piece and a second folding piece that are respectively in rotatable connection with the rotating shaft, wherein:
the first folding piece is connected to the first panel, and the second folding piece is connected to the second panel.

14. The bed according to claim 10, further comprising at least one fastening member, wherein when the at least two panels are in an unfolded state, the fastening member is disposed across the at least two panels, a first end of the fastening member being connected to a first panel, a second end of the fastening member being connected to a last panel.

15. The bed according to claim 14, wherein the fastening member comprises a fixed connecting piece, a first fastening piece and a second fastening piece; wherein:
the fixed connecting piece is disposed across the at least two panels, one end of the fixed connecting piece being secured to the first panel via the first fastening piece, the other end of the fixed connecting piece being secured to the last panel via the second fastening piece.

16. The bed according to claim 15, wherein the fixed connecting piece selects a screw fixed connecting piece; and/or, the first fastening piece and the second fastening piece select a bolt fastening piece.

17. The bed according to claim 10, wherein the headboard further comprises at least two soft coverings, the soft coverings sequentially wrapping the corresponding panels; or, the at least two soft coverings are integrally formed to wrap the at least two panels so as to conceal the folding connection member.

18. The bed according to claim 10, further comprising a third panel arranged between the first panel and the second panel, the third panel being respectively in foldable connection with the first panel and the second panel.
